(19) United States
(12) Patent Application Publication
(10) Pub. No.: US 2025/0238041 A1
(43) Pub. Date: Jul. 24, 2025

(54) UNMANNED AERIAL VEHICLE AND OPERATION METHOD THEREOF

(71) Applicant: Qisda Corporation, Taoyuan City (TW)

(72) Inventors: Chih-Ming CHANG, Taoyuan City (TW); Po-Fu WU, Taoyuan City (TW)

(73) Assignee: Qisda Corporation, Taoyuan City (TW)

(21) Appl. No.: 19/007,680

(22) Filed: Jan. 2, 2025

(30) Foreign Application Priority Data
Jan. 23, 2024 (CN) 202410090601.X

(51) Int. Cl. G05D 1/86; B64D 45/00; B64U 10/14; G05D 109/25; G05D 111/50

(52) U.S. Cl. CPC G05D 1/86; B64U 10/14; B64D 2045/0085; G05D 2109/254; G05D 2111/52

(57) ABSTRACT

An unmanned aerial vehicle and an operation method thereof are provided. The unmanned aerial vehicle includes a main body, a first inertial measurement module, a second inertial measurement module and a control module. The first inertial measurement module is coupled to the main body through a damping element. The second inertial measurement module is directly connected to the main body without relying on any damping element. The second inertial measurement module is configured to detect a vibration value of the main body. The control module electrically connects to the first inertial measurement module and the second inertial measurement module. The control module is configured to determine whether a pre-flight state of the unmanned aerial vehicle is abnormal according to the vibration value.

This application claims the benefit of People's Republic of China application Serial No. 202410090601.X, filed Jan. 23, 2024, the disclosure of which is incorporated by reference herein in their entirety.

### TECHNICAL FIELD

The present invention relates to an unmanned aerial vehicle and an operation method thereof.

### BACKGROUND

The stable flight of an unmanned aerial vehicle involves elements such as propellers, electrical motors and arms. Particularly, if the unmanned aerial vehicle is equipped with foldable arms, it is essential to assure that all arms have been unfolded to their predetermined positions before the unmanned aerial vehicle takes off. In the pre-flight state of the unmanned aerial vehicle, the user normally determines whether there are any abnormalities with the unmanned aerial vehicle through visual inspection. However, visual inspection may omit some flight failure factors of the unmanned aerial vehicle.

Therefore, it has become a prominent task for those skilled in the art to further assure the flight safety of the unmanned aerial vehicle.

### SUMMARY

According to an aspect of the present invention, an unmanned aerial vehicle is provided. The unmanned aerial vehicle includes a main body, a first inertial measurement module, a second inertial measurement module and a control module. The first inertial measurement module is coupled to the main body through a damping element. The second inertial measurement module is directly connected to the main body without relying on any damping element. The second inertial measurement module is configured to detect a vibration value of the main body. The control module electrically connects to the first inertial measurement module and the second inertial measurement module. The control module is configured to determine whether a pre-flight state of the unmanned aerial vehicle is abnormal according to the vibration value.

According to another aspect of the present invention, an operation method of an unmanned aerial vehicle is provided. The operation method includes the following steps. An unmanned aerial vehicle is provided, wherein the unmanned aerial vehicle includes a main body, a first inertial measurement module, a second inertial measurement module and a control module; the first inertial measurement module is coupled to the main body through a damping element, the second inertial measurement module is directly connected to the main body without relying on any damping element, and the control module electrically connects to the first inertial measurement module and the second inertial measurement module. A vibration value of the main body is detected by the second inertial measurement module. Whether a pre-flight state of the unmanned aerial vehicle is abnormal is determined by the control module according to the vibration value.

In comparison to the prior art, the unmanned aerial vehicle and the operation method thereof provided in the present invention can provide a detection mechanism of the pre-flight state of the unmanned aerial vehicle to assure flight safety of the unmanned aerial vehicle. Thus, the unmanned aerial vehicle and the operation method thereof provided in the present invention can resolve the problem encountered in the prior art. In the prior art, flight failure factors of the unmanned aerial vehicle may not be fully detected because the detection relies on visual inspection only.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an appearance diagram of an unmanned aerial vehicle according to an embodiment of the present invention.

FIG. 2 is a system diagram of an unmanned aerial vehicle according to an embodiment of the present invention.

FIG. 3 is a partial internal layout of an unmanned aerial vehicle according to an embodiment of the present invention.

FIG. 4 and FIG. 5 are flowcharts of an operation method of an unmanned aerial vehicle according to an embodiment of the present invention.

FIG. 6 is a partial flowchart of an operation method of an unmanned aerial vehicle according to an embodiment of the present invention.

### DETAILED DESCRIPTION

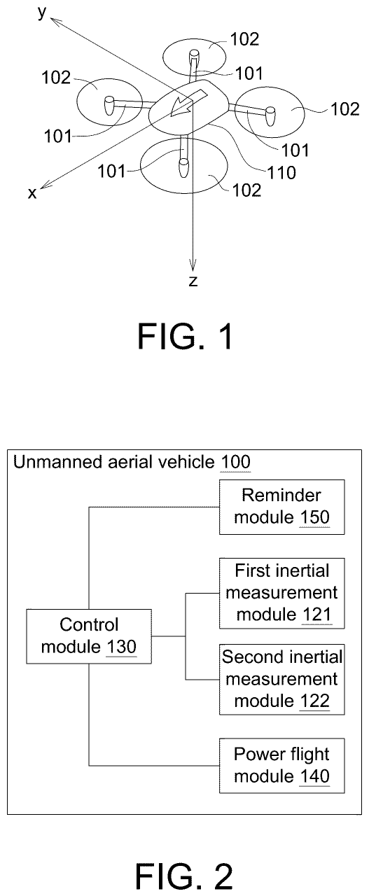

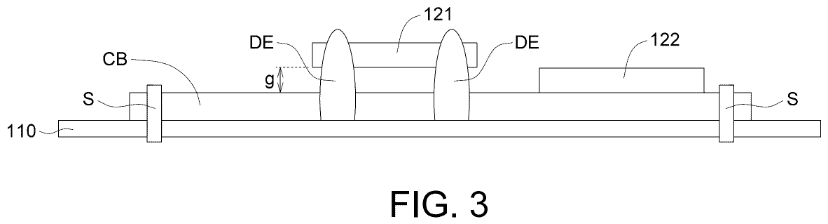

Please refer to FIG. 1, FIG. 2 and FIG. 3. FIG. 1 is an appearance diagram of an unmanned aerial vehicle 100 according to an embodiment of the present invention. FIG. 2 is a system diagram of an unmanned aerial vehicle 100 according to an embodiment of the present invention. FIG. 3 is a partial internal layout of an unmanned aerial vehicle 100 according to an embodiment of the present invention.

As indicated in FIG. 1, the unmanned aerial vehicle 100 includes a main body 110. The unmanned aerial vehicle 100 has four arms 101, each having a propeller 102. The propeller 102 can rotate to generate a lifting force with which the unmanned aerial vehicle 100 can fly above the ground. By taking the main body 110 as a datum, a first axial direction x, a second axial direction y and a third axial direction z can be defined, wherein the first axial direction x, the second axial direction y and the third axial direction z are perpendicular to each other. The third axial direction z is an orientation parallel to the gravity direction. Two orientations, that is, the first axial direction x and the second axial direction y, can form a plane perpendicular to the gravity direction.

As indicated in FIG. 2, the unmanned aerial vehicle 100 includes a first inertial measurement module 121, a second inertial measurement module 122, a control module 130, a power flight module 140 and a reminder module 150. The control module 130 can electrically connect the first inertial measurement module 121, the second inertial measurement module 122, the power flight module 140 and the reminder module 150. The first inertial measurement module 121 and the second inertial measurement module 122 are elements for measuring tri-axial attitude angle or angular rate and acceleration. The first inertial measurement module 121 and the second inertial measurement module 122 can be realized by any of a gyroscope and an acceleration sensor or a combination thereof, but the present invention is not limited thereto. Depending on actual needs (such as an increase in reliability), the first inertial measurement module 121 and the second inertial measurement module 122 can be realized by a combination of more sensors for inertial measurement, and combinations are not exemplified here one by one. The control module 130 can be realized by a chip or a circuit block, a firmware circuit, or a circuit board containing several electronic components and wires inside a chip. The power flight module 140 may include a propeller 102 and an electrical motor (not illustrated). The electrical motor can be activated by the control module 130 to drive the propeller 102 to rotate and provide a flight power to the unmanned aerial vehicle 100. The reminder module 150 provides a warning in the form of sound or image, and can be realized by a buzzer installed in the main body 110 or a display screen arranged on a remote controller of the unmanned aerial vehicle 100.

As indicated in FIG. 3, the first inertial measurement module 121 can be coupled to the main body 110 through a damping element DE, but the second inertial measurement module 122 is directly connected to the main body 110 without relying on any damping element. The damping element DE can absorb the vibration of the main body 110, that is, the first inertial measurement module 121 can detect a flight attitude of the main body 110 under a buffering effect provided by the damping element DE and further provides the detected flight attitude for the control module 130 to perform flight control. The main body 110 can include a circuit board CB. Exemplarily but not restrictively, the circuit board CB can be fixed in the main body 110 by a screw S. The first inertial measurement module 121 is installed in the circuit board CB through the damping element DE, so that a gap g is formed between the first inertial measurement module 121 and the circuit board CB.

Unlike the first inertial measurement module 121 which is configured to detect a flight attitude, the second inertial measurement module 122 is configured to detect a vibration value of the main body 110 and must be directly connected to the main body 110. The unit of measurement of vibration value is standard gravity, that is, about 9.8 m/s². If the second inertial measurement module 122 is coupled to the main body 110 through a damping element, the damping element will absorb the vibration of the main body 110 and affect vibration detection of the second inertial measurement module 122. In other words, the second inertial measurement module 122 is coupled to the circuit board CB in an immovable manner. In the present embodiment, the second inertial measurement module 122 is bonded to the circuit board CB using a surface mount technology (SMT), and is referred as a surface mount device (SMD). However, the present invention is not limited thereto. Apart from the surface mount technology, the locking technology using a fastener (such as a screw) is also implemented in an immovable manner.

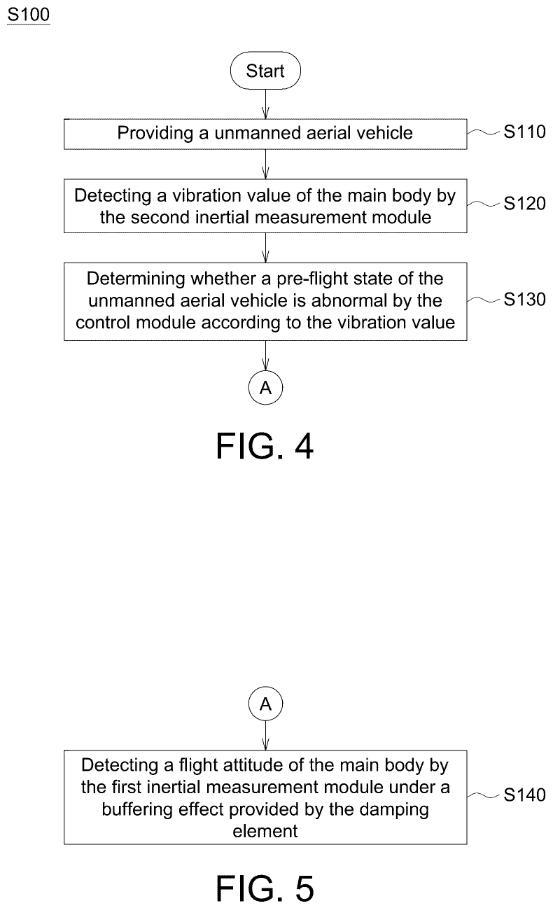

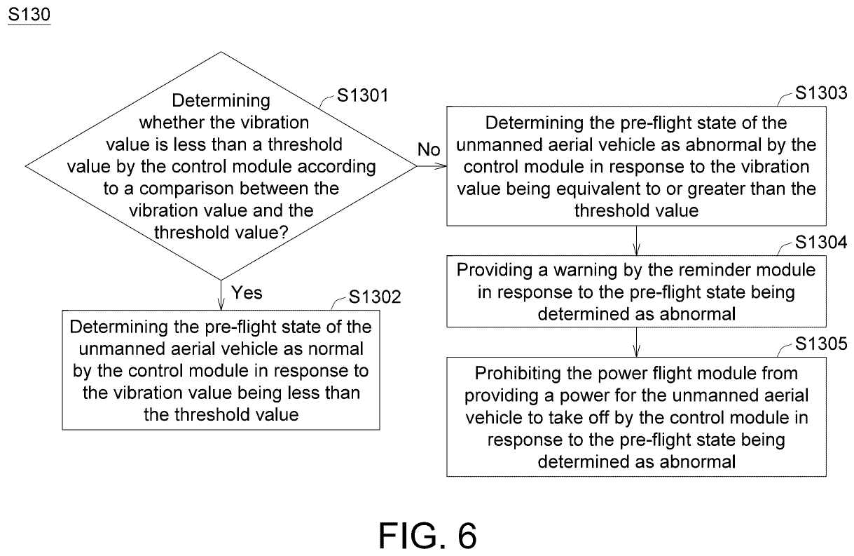

Please refer to FIG. 4, FIG. 5 and FIG. 6. FIG. 4 and FIG. 5 are flowcharts of an operation method S100 of an unmanned aerial vehicle according to an embodiment of the present invention. FIG. 6 is a flowchart of sub-steps of step S130 an operation method S100 of an unmanned aerial vehicle according to an embodiment of the present invention. The operation method S100 corresponds to the operations of the unmanned aerial vehicle 100.

In step S110, an unmanned aerial vehicle 100 is provided, wherein the unmanned aerial vehicle 100 can be in a power-on state and placed on a ground, that is, the power flight module 140 is in a startup state. In step S120, a vibration value of the main body 110 is detected by a second inertial measurement module 122. Meanwhile, what is detected by the second inertial measurement module 122 is the vibration value of the unmanned aerial vehicle 100 before taking off from the ground. To be more specifically, the second inertial measurement module 122 detects the vibration value of the main body 110 along at least one of the first axial direction x, the second axial direction y and the third axial direction z.

In step S130, whether the pre-flight state of the unmanned aerial vehicle 100 is abnormal is determined by a control module 130 according to the vibration value detected by the second inertial measurement module 122. In sub-step S1301 as indicated in FIG. 6, whether the vibration value detected by the second inertial measurement module 122 is less than a threshold value is determined by the control module 130 according to a comparison between the vibration value detected by the second inertial measurement module 122 and a threshold value. The threshold value is pre-stored in the unmanned aerial vehicle 100, and its actual value can be adjusted according to actual needs. Specifically, the control module 130 compares the vibration value detected by the second inertial measurement module 122 with the threshold value after the power flight module 140 has been activated for a period of time. That is, the vibration value detected after the power flight module 140 has been activated for a period of time provides greater reference value because it is obtained when the unmanned aerial vehicle 100 is on the ground and in a stable stand-by state, so that the determination of the pre-flight state made by the control module 130 through comparison is more accurate.

In sub-step S1302, the pre-flight state of the unmanned aerial vehicle 100 is determined as normal by the control module 130 in response to the vibration value detected by the second inertial measurement module 122 being less than the threshold value, and the unmanned aerial vehicle 100 is allowed to take off.

In step S140 as indicated in FIG. 5, after the unmanned aerial vehicle 100 takes off and starts to fly, a flight attitude of the main body 110 is detected by the first inertial measurement module 121 under a buffering effect provided by the damping element DE. This is to ensure that inertial measurement is performed only after the unmanned aerial vehicle 100 has passed pre-flight detection.

Conversely, in sub-step S1303, the pre-flight state of the unmanned aerial vehicle 100 is determined as abnormal by the control module 130 in response to the vibration value detected by the second inertial measurement module 122 being equivalent to or greater than the threshold value. Examples of abnormal pre-flight state of the unmanned aerial vehicle 100 include the arms 101 failing to be unfolded to their predetermined positions hence making the thrust unbalanced, screws coming off the propeller 102, or the electrical motor generating abnormal thrust. In these scenarios, the main body 110 vibrates greatly, becomes unstable, and will cause danger during the flight.

In sub-step S1304, in response to the pre-flight state of the unmanned aerial vehicle 100 being determined as abnormal, a warning (sound or image) is sent by the reminder module 150 to remind the user that the unmanned aerial vehicle 100 is currently not suitable to take off.

Then, in sub-step S1305, in response to the pre-flight state of the unmanned aerial vehicle 100 being determined as abnormal, the power flight module 140 is prohibited by the control module 130 from providing a power for the unmanned aerial vehicle 100 to take off, and/or the power flight module 140 is directly shut down by the control module 130.

To summarize, according to the unmanned aerial vehicle and the operation method thereof provided in the present invention, through the disposition of dual inertial measurement modules, the inertial measurement module coupled to the main body without relying on any damping element is configured to detect a pre-flight vibration value of the unmanned aerial vehicle for the control module to determine whether the unmanned aerial vehicle is suitable to take off, and the other inertial measurement module coupled to the main body through a damping element is configured to detect an attitude information of the unmanned aerial vehicle during flight for the control module to perform flight control. Thus, the unmanned aerial vehicle and the operation method thereof provided in the present invention can resolve the problem encountered in the prior art. In the prior art, flight failure factors of the unmanned aerial vehicle may not be fully detected because the detection relies on visual inspection only.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An unmanned aerial vehicle, comprising:
a main body;
a first inertial measurement module coupled to the main body through a damping element;
a second inertial measurement module directly connected to the main body without relying on any damping element, wherein the second inertial measurement module is configured to detect a vibration value of the main body; and
a control module electrically connecting to the first inertial measurement module and the second inertial measurement module, wherein the control module is configured to determine whether a pre-flight state of the unmanned aerial vehicle is abnormal according to the vibration value.

2. The unmanned aerial vehicle according to claim 1, wherein the control module is configured to compare the vibration value with a threshold value and to determine the pre-flight state as abnormal in response to the vibration value being equivalent to or greater than the threshold value.

3. The unmanned aerial vehicle according to claim 1, further comprising a reminder module, wherein the reminder module is configured to provide a warning in response to the pre-flight state being determined as abnormal.

4. The unmanned aerial vehicle according to claim 1, wherein the control module is configured to compare the vibration value with a threshold value and to determine the pre-flight state as normal in response to the vibration value being less than the threshold value, and then the unmanned aerial vehicle is allowed to take off.

5. The unmanned aerial vehicle according to claim 1, the first inertial measurement module is configured to detect a flight attitude of the main body under a buffering effect provided by the damping element.

6. The unmanned aerial vehicle according to claim 2, further comprising a power flight module, wherein the control module is configured to compare the vibration value with the threshold value after the power flight module has been activated for a period of time.

7. The unmanned aerial vehicle according to claim 1, further comprising a power flight module, wherein the control module electrically connects to the power flight module, and shuts down the power flight module in response to the pre-flight state being determined as abnormal.

8. The unmanned aerial vehicle according to claim 1, further comprising a power flight module, wherein the control module electrically connects to the power flight module, and prohibits the power flight module from providing a power for the unmanned aerial vehicle to take off in response to the pre-flight state being determined as abnormal.

9. The unmanned aerial vehicle according to claim 1, wherein the second inertial measurement module is configured to detect a vibration value of the main body along at least one of a first axial direction, a second axial direction and a third axial direction; the first axial direction, the second axial direction and the third axial direction are perpendicular to each other.

10. The unmanned aerial vehicle according to claim 1, wherein the main body contains a circuit board, the first inertial measurement module is installed in the circuit board through the damping element, and the second inertial measurement module is coupled to the circuit board in an immovable manner.

11. An operation method of an unmanned aerial vehicle, comprising:
providing an unmanned aerial vehicle, wherein the unmanned aerial vehicle comprises a main body, a first inertial measurement module, a second inertial measurement module and a control module; the first inertial measurement module is coupled to the main body through a damping element, the second inertial measurement module is directly connected to the main body without relying on any damping element, and the control module electrically connects to the first inertial measurement module and the second inertial measurement module;
detecting a vibration value of the main body by the second inertial measurement module; and
determining whether a pre-flight state of the unmanned aerial vehicle is abnormal by the control module according to the vibration value.

12. The operation method according to claim 11, wherein the step of “determining, by the control module, whether a pre-flight state of the unmanned aerial vehicle is abnormal according to the vibration value” comprises:
comparing the vibration value with a threshold value by the control module; and
determining the pre-flight state as abnormal by the control module in response to the vibration value being equivalent to or greater than the threshold value.

13. The operation method according to claim 11, wherein the unmanned aerial vehicle further comprises a reminder module, and the operation method further comprises:
providing a warning by the reminder module in response to the pre-flight state being determined as abnormal.

14. The operation method according to claim 11, wherein the step “determining whether a pre-flight state of the unmanned aerial vehicle is abnormal by the control module according to the vibration value” comprises:
comparing the vibration value with a threshold value by the control module; and
determining the pre-flight state as normal and allowing the unmanned aerial vehicle to take off by the control module in response to the vibration value being less than the threshold value.

15. The operation method according to claim 11, further comprising:
detecting a flight attitude of the main body by the first inertial measurement module under a buffering effect provided by the damping element.

16. The operation method according to claim 12, wherein the unmanned aerial vehicle further comprises a power flight module, and the operation method further comprises:
comparing the vibration value with the threshold value by the control module after the power flight module has been activated for a period of time.

17. The operation method according to claim 14, wherein the unmanned aerial vehicle further comprises a power flight module, and the operation method further comprises:
comparing the vibration value with the threshold value by the control module after the power flight module has been activated for a period of time.

18. The operation method according to claim 11, wherein the unmanned aerial vehicle further comprises a power flight module, the control module electrically connects to the power flight module, and the operation method further comprises:
shutting down the power flight module by the control module in response to the pre-flight state being determined as abnormal.

19. The operation method according to claim 11, wherein the unmanned aerial vehicle further comprises a power flight module, the control module electrically connects to the power flight module, and the operation method further comprises:
prohibiting the power flight module from providing a power for the unmanned aerial vehicle to take off by the control module in response to the pre-flight state being determined as abnormal.

20. The operation method according to claim 11, wherein the step of detecting the vibration value of the main body by the second inertial measurement module comprises:
detecting the vibration value of the main body along at least one of a first axial direction, a second axial direction and a third axial direction by the second inertial measurement module, wherein the first axial direction, the second axial direction and the third axial direction are perpendicular to each other.
